(19) United States
(12) Patent Application Publication
(10) Pub. No.: US 2006/0093912 A1
(43) Pub. Date: May 4, 2006

(54) Paste curing additive

(76) Inventor: George E. Mayer, Venetia, PA (US)

Correspondence Address: John A. Parrish;Law Offices of John A. Parrish, Suite 300, Two Bala Plaza, Bala Cynwyd, PA, 19004, US

(21) Appl. No.: 11/234,077

(22) Filed: Sep. 23, 2005

Related U.S. Application Data
(60) Provisional application No. 60/612,417, filed on Sep. 23, 2004.
(60) Provisional application No. 60/660,133, filed on Mar. 9, 2005.

(51) Int. Cl. H01M 4/58; C01G 21/20; H01M 4/62

(52) U.S. Cl. 429/227; 252/182.1; 423/559; 429/217

(57) ABSTRACT

The disclosed invention relates to additives for use in, such as, battery pastes and in polymers. The additive is the reaction product of sulphuric acid, water and leady oxide. The additive may be used in a mixture of sulphuric acid, water and leady oxide to produce a modified battery paste that, when pasted onto battery plates, yields plates of improved performance. The additive also may be used as a stabilizer for chlorine containing polymers such as polyvinyl chloride.

This application claims priority to U.S. Provisional Application USSN 60/612,417 filed Sep. 23, 2004 and U.S. Provisional Application USSN 60/660,133 filed Mar. 9, 2005.

### TITLE OF THE INVENTION

Paste Curing Additive

### FIELD OF THE INVENTION

The invention generally relates to battery pastes and to additives for improving the performance of battery pastes.

### BACKGROUND OF THE INVENTION

An important and time-consuming aspect of manufacture of lead-acid batteries is the curing of wet active paste material precursor into a dry porous mass. The paste precursor typically is in the form of flakes of “leady oxide”, i.e. flakes of solidified lead particles which bear a PbO coating. The leady oxide is made into a wet, pliable dough (‘paste’) by mixing it with water and then with sulfuric acid. The dough then is extruded onto mechanically rigid, electrically conductive grids in a process called “pasting”. The resulting pasted grids are cured at elevated temperature and humidity to react PbO with sulphuric acid to form lead sulfate salts, and to oxidize the lead core of the leady oxide to PbO to form additional lead sulfate salts.

Lead sulfate salts which provide mechanical strength and porosity to the leady oxide paste, and ultimately to the active material include tribasic lead sulfate 3PbOPbSO₄H₂O (“3BS”) and tetrabasic lead sulfate 4PbOPbSO₄ (“4BS”). The 3BS typically forms at low temperature and low humidity, whereas 4BS typically forms at higher temperatures (>70° C.) and higher humidity. The 3BS typically forms as small needle-like crystals which measure about 3 microns long and less than about 1 micron in each of width and thickness. The 4BS crystals are larger, and grow in length from several microns to several hundred microns. The longer 4BS crystals have width and thickness in proportion to length. For example, a 300 micron long 4BS crystal might have a width of 60 microns and a thickness of 50 microns. A 4BS crystal that measures 300 microns long by 60 microns wide and 50 microns thick has a surface area of 72000 square microns, and a volume of 900,000 cubic microns. This volume, when tightly packed with the smaller 3BS crystals, would hold about 10⁷ 3BS crystals which have a total surface area of about 7.2×10⁶ square microns, i.e. 1000 times greater surface area. The size and shape of the crystals in the cured paste can be measured by scanning electron microscopy (SEM). The amounts of the 3BS and 4BS crystals may be determined by x-ray diffraction (XRD).

The composition of a cured pasted plate can also be estimated visually. Lead oxides are yellowish to brownish in color and 3BS is white. When 3BS is present in cured plates, the 3BS has a pale peach color that corresponds to Sears paint color chip 224. The presence of 4BS is revealed by a deep orange color that corresponds to Sears paint color chip # 225 or #221. Sometimes 4BS in cured pasted plates has a dark greenish color due to presence of unoxidized free Pb. Unoxidized free Pb is undesirable since it preferentially reacts with sulfuric acid to produce PbSO₄ during the soak and formation process. The PbSO₄ is difficult to convert to lead dioxide, and reduces plate capacity.

The production of 4BS generally requires very careful control of temperature and humidity during cure of the pasted plates. Premature dryout and/or cooling of the plates inhibit the formation of 4BS. Some battery manufacturers specify control and uniformity to ±2° C. and ±1% relative humidity (RH) compared to setpoints. It has generally been observed that addition of red lead (Pb₃O₄) allows adequate processing to produce 4BS over a larger range of temperature and relative humidity relative to setpoints.

Production of 4BS entails nucleation and growth. Nucleation is afforded by exposing the pasted plates to temperatures of about 70° C. or higher at high humidity at the beginning of cure. Nucleation during cure can have an induction period of about 10 hours since 4BS forms as molecules which slowly coalesce by diffusion into seeds. These seeds can react with additional nearby material to grow into crystals. The growth rate of the 4BS crystals depends on various factors such as the composition of the oxide used, the oxide to sulphuric acid ratio in the paste mixture, the mixer type, mixing time, mixing temperature, temperatures between process steps, flash dry conditions, as well as the temperature and humidity inside the curing chamber.

The growth of 4BS can proceed by two mechanisms. Large isotropic and “regular”, i.e. uniaxial crystals, can be prepared by preferential deposition of a material onto one face of a seed crystal by a screw-dislocation or a slip-plane mechanism. Since only one face of each crystal grows, the process is slow. Crystals grown by this mechanism have smooth crystal faces and sharp angles between adjacent faces. Anisotropic crystals may be produced faster by fractal growth. Fractal growth entails growing the crystals at many locations and in many different directions simultaneously, i.e. multiaxially. The resulting, fractal crystals are irregular and smaller in size. Fractal crystal growth may be confirmed by plotting “quantity produced” vs. time. Regular growth provides a straight-line linear plot. Fractal growth provides a straight-line log-log plot. Fractal crystal growth may produce greater mechanical strength in a paste pellet because the multiaxial crystals interlock better than the uniaxial crystals do. Fractal growth also may produce better electrical conductivity when the paste. Some battery manufacturers prefer 3BS over 4BS for engine cranking (SLI) batteries which may be flooded, gelled or absorptive glass mat (AGM) in design. Traditionally, curing creates highly variable yields of 4BS which have a large crystal size, low surface area per unit weight, and a small amount of very large pores. This variability in yield and the undesired crystallinity and porosity tends to cause variable (and generally poor) battery cranking performance in SLI batteries.

When curing is adjusted to preclude nucleation and growth of 4BS, a predominance of 3BS is produced. The 3BS has uniform crystal shape and size (3 microns×0.5 microns×0.5 microns). When a plate is pasted with 3BS the plate has a uniform porosity and high cranking performance.

Historically, free Pb was a desired component of battery paste. The free Pb was thought to generate heat during cure of the pasted battery plates to enhance production of 3BS, 4BS and porosity. This heating, however, was uncontrolled and erratic, and the resultant plates did not always have the composition and/or porosity desired.

Free Pb is now considered undesirable. A high amount (more than about 2 wt. %) of free Pb at the end of curing can lead to shedding and spalling failure of the positive plates and/or high self-discharge of “formed” PbO₂ plates.

The amount of free Pb in leady oxides typically is about 25 wt. %, but can form in amounts of 20 to 40 wt. % free Pb. It is difficult and costly to produce a leady oxide with about 15 wt. % or less free Pb, and even more costly to produce a nonleady oxide. Discharge capacity of a battery depends on the porosity and surface area of the porous battery electrode, usually the positive electrode, which for a lead-acid battery is the lead dioxide electrode. Lead dioxide electrodes which have a larger surface area have a higher discharge capacity, and higher utilization of the active material at any rate of discharge. In high discharge rate batteries such as SLI batteries, 3BS is the preferred active material precursor. 4BS is the preferred material precursor for deep cycle and long-life stationary batteries. 4BS is also the preferred precursor for use in modern nonantimonial grid batteries, the so-called “maintenance-free” batteries for SLI, float or cycling application, because the 4BS helps prevent PCL (premature capacity loss), i.e. short battery life.

Curing promotes adhesion of battery paste to the grid. The battery paste, which has an alkaline pH, reacts with lead alloy in the grid to partially convert the lead alloy to Pb compounds and ultimately to 3BS and 4BS. Generally, the higher the temperature employed during cure, the better the adhesive bond produced.

Production of 4BS depends on nucleation and growth. One way to get 4BS nuclei immediately into a battery paste is to use 4BS seed crystals prepared by grinding large crystals of pure 4BS. This, however, is very costly. Large 4BS can be made by the well known processes. These processes, however, are slow, and yield only a small amount of 4BS in copious amounts of liquid. Another way to produce 4BS is to use an Eirich mixer wherein 4BS is made into more concentrated slurry, and then excess water is removed by vacuum and heat. A pyrometallurgical reactor (Barton pot) also may be used to make 4BS. A slurry reactor and reactive grinding may be also be used to make 4BS. These methods, however, do not produce multiaxial crystals of 4BS, or seed crystals which can grow multiaxial crystals in battery plat

A need therefore exists for improved formation of 4BS and 3BS crystals during cure of battery paste. In addition, a need exists for a paste curing additive to enhance curing of pasted battery plates such as pasted battery plates for lead-acid batteries.

There also is a need for an additive for battery paste for use in lead acid battery positive plates and negative plates where the additive may be employed to enhance production of (4BS) during cure of the paste and where the additive also may be used to enhance production of (3BS) during cure of the paste.

There is a need for a paste curing additive to speed oxidation of free lead residue in pasted plates during cure, thereby reducing the cure time of active material paste and the amount of energy required during curing.

A need also exists for an additive and a process which reduces the time and cost of the curing of wet active material paste into a dry porous mass and which uses less expensive precursor materials than the litharge commonly used to make 4BS.

Basic lead sulfate salts also have been used as stabilizers in chlorovinyl polymer plastics such as polyvinyl chloride (PVC) to minimize degradation of the polymer from exposure to heat and/or light, especially UV light. The lead in these salts can capture evolved chlorine-containing degradation products from both proliferation and release by forming immobile, insoluble, stable lead chloride. A need exists for improved stabilizer lead sulfates for plastics.

### SUMMARY OF THE INVENTION

The invention relates to a paste curing additive (“PCA”) for battery paste for use in, such as, lead acid battery positive plates. The additive may be employed to enhance production of tetrabasic lead sulfate (4BS) and smaller crystals of 4BS during cure of battery paste, as well as to grow the 4BS in multiaxial crystal groupings. PCA contains little if any 4BS and may be used to reduce the cure time of active material paste, as well as to reduce the amount of energy required during curing.

The additive also may be used to enhance production of tribasic lead sulfate (3BS) during cure of battery paste. The PCA may be used to enhance curing of pasted battery plates, especially pasted battery plates intended for lead-acid batteries.

PCA also may be used to achieve greater porosity in the form of higher numbers of pores as well as larger sizes of pores in the cured plate. PCA also may be used to speed oxidation of free lead residue in pasted plates during cure. PCA also may be used to enhance adhesion of the cured paste to the grid.

The PCA enables increased crystallinity and porosity in the cured paste, as well as faster reduction of the amount of free lead in the cured paste. This may provide greater utilization of the active material and easier conversion from the non-active “paste” state to the “active material” state.

PCA in amounts of about 1 wt. % to about 12 wt. % based on the weight of leady oxide may be used to speed the cure of battery plates at temperatures of about 56° C. to about 100° C. at RH of about 10% to about 100%. Also, lead acid battery plates which include PCA may cure faster and may show improved performance.

The use of PCA may improve development of crystals of lead sulfates such as 3BS and 4BS, may enhance more rapid development of porosity and the oxidation of free lead.

Basic lead sulfate salts also have been used as stabilizers in chlorovinyl polymer plastics such as polyvinyl chloride (PVC) to minimize degradation of the polymer from exposure to heat and/or light, especially UV light. The lead in these salts can capture evolved chlorine-containing degradation products from both proliferation and release by forming immobile, insoluble, stable lead chloride.

In one aspect, the PCA is produced as the reaction product formed by heating a battery paste to a temperature of about 80° C. to about 90° C. for about 5 min. to about 10 min., wherein the battery paste includes sulfuric acid in an amount of about 5 wt. % to about 6 wt. %, water in an amount of about 12 wt. % to about 16 wt. %, and balance leady oxide, all amounts based on total weight of sulphuric acid, water and leady oxide. The additive may be then be used in any of its dried or undried states.

In a second aspect, the PCA is produced as the reaction product formed heating a battery paste to a temperature of about 70° C. to about 90° C. for about 10 min. to about 90 min., wherein the battery paste includes sulfuric acid in an amount of about 3 wt. % to about 10 wt. %, water in an amount of about 10 wt. % to about 20 wt. %, and balance leady oxide, all amounts based on total weight of sulphuric acid, water and leady oxide.

In a third aspect, the invention relates to a polymeric composition which includes a paste curing additive in admixture with a chlorine containing polymer. The polymeric composition includes a chlorine containing polymer and a paste curing additive present in an amount of about 2 wt. % to about 10 wt. % based on the weight of the chlorine containing polymer. The additive may be used in any of its oxidized or unoxidized states. The additive is the reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide, and the additive has a particle size of about 1 micron to about 70 microns.

In a fourth aspect, the invention relates to a battery plate pasted with a battery paste that includes comprising a paste curing additive in admixture with a composition that includes comprising sulphuric acid, water and leady oxide, wherein the additive is the dried or undried reaction product formed by heating a mixture of sulfuric acid, water and leady oxide wherein the sulphuric acid is present in the mixture in an amount of about 3 wt. % to about 10 wt. %, the water is present in the mixture in an amount of about 10 wt. % to about 20 wt. %, and leady oxide is present in the mixture in an amount that is the balance of the mixture, all amounts based on total weight of the mixture of sulphuric acid, water and leady oxide, and the additive is present in the composition in an amount of about 5 wt. % to about 95 wt. % based on the weight of leady oxide.

### DETAILED DESCRIPTION OF THE INVENTION

Materials Used to Make PCA

PCA may be produced from battery pastes which include a wide range of amounts of leady oxide, sulfuric acid and excess water, i.e. water sufficient to attain a mixable paste. The leady oxides may have a wide range of free Pb content. Calcined red lead may be substituted for leady oxide in the paste compositions used to produce PCA.

Battery pastes which may be used to make PCA include sulfuric acid in an amount of about 3 wt. % to about 10 wt. %, preferably about 5 wt. % to about 6 wt. %, water in an amount of about 10 wt. % to about 20 wt. %, preferably about 12 wt. % to about 16 wt. %. and balance leady oxide, all amounts based on total weight of sulphuric acid, water and leady oxide.

Procedure for Manufacture of PCA

PCA may be produced by “cooking” battery paste under conditions of high relative humidity as arises where excess water is present in the paste. The battery paste typically is heated to a temperature of about 70° C. to about 100° C. for about 10 to about 90 minutes, preferably about 80° C. to about 90° C. for about 2 min. to about 60 min., more preferably about 5 min. to about 10 min.

The PCA can be utilized as this “cooked” paste. Preferably, the cooked paste is dried and ground to achieve a free-flowing PCA powder. The PCA may include 4BS crystallites, 3BS crystallites, unreacted leady oxide and free lead. The PCA typically has about 0 wt. % 3BS to about 80wt. % 3BS and about 0 wt. % 4BS to about 80wt. % 4BS, remainder unoxidized free lead and unreacted PbO. Presence of 3BS in the PCA can aid in nucleation of additional 3BS. Presence of 4BS in PCA can aid in nucleation of 4BS crystals which may grow to sizes of about 2 microns to about 100 microns during cure of paste which includes PCA.

The PCA may be stored in sealed containers to exclude carbon dioxide so to prevent formation of lead carbonates in or on the PCA.

PCA Modified Battery Paste

PCA modified paste is formed by making a mixture of PCA and wet battery paste. PCA preferably is added as a dry powder to leady oxide, and this mixture is further mixed with water and sulfuric acid to produce a paste. Undried PCA may be added in amounts of about 5 wt. % to about 95wt. %, preferably about 50 wt. % to about 60 wt. %, all amounts based on weight of leady oxide in the final paste. The dry powder form of PCA may be added in amounts of about 1 wt. % to about 95 wt. %, preferably about 1 wt. % to about 10 wt. % based on the weight of the leady oxide in the paste, to the battery paste that includes leady oxide, water and sulfuric acid. The leady oxide may be produced by a Barton pot or a ball mill.

PCA also may be employed with a non-additive solid such as a non-leady oxide such as red lead, litharge or other lead compounds or salts. Battery plates such as positive plates which include PCA may be assembled into cells and batteries.

PCA for addition to battery pastes may have up to about 5 wt. % residual moisture. The PCA may be ground in a variety of grinders such as food mills, high speed attrition mills, as well as manually operated mortar and pestle to useful particle size range of about 100 mesh to less than about 3 microns.

A range of particle sizes of PCA may be added to battery pastes. Typically, PCA which has a particle size of about 150 microns to about 0.5 microns may be added to the paste. Colloidal PCA also may be added to the paste. Mixtures of large and small particle sizes of PCA also may be added to the paste. Mixtures which may be used include about 0.5% to about 99.5% PCA which have a particle size of about 0.5 micron to about 50 micron, and about 99.5% to about 0.5% PCA which have a particle size of about 50 microns to about 200 microns.

The PCA modified paste is cooked at temperatures of about 30° C. to about 100° C. for about 10 min. to about 150 min., preferably about 80° C. to about 100° C. for about 10 min. to about 150 min. to make additional PCA. Alternatively, uncooked PCA modified paste then is pasted into grids and cured to make improved cured battery plates. Curing of PCA modified pastes typically is at about 50° C. to about 100° C. at about 10% RH to about 100% RH for 12 hr. to about 48 hr.

Cooked PCA modified paste may be dried at any temperature from ambient air at less than 100% RH to oven drying at up to about 400° C. and humidity down to 0% RH. Drying time is inversely related to drying temperature and directly related to RH, i.e. higher temperatures and lower humidities dry PCA faster. The PCA modified paste, as well as PCA per se, may be continuously mixed and heated in a mixer until reduced to balls of about 5 mm to about 30 mm diameter, preferably to fine grains of about 0.5 mm to about 5 mm diameter, more preferably about 2 microns to about 50 microns diameter.

The aforedescribed mixing and heating process may be performed using a variety of heat sources such as electrical heat sources or combustion-operated heat sources. Combustion heat sources may be direct where combustion products including carbon dioxide are impinged directly onto the paste or indirect where hot air without substantial carbon dioxide impinges upon the paste.

Properties of PCA Modified Pastes

Cured PCA modified pastes typically have multiaxial 4BS crystals which have several or more arms which protrude outwardly from a central core. By comparison, only uniaxial 4BS crystals are observed in pastes which employ commercial ground, slurry-produced 4BS and which do not include PCA.

PCA modified wet battery pastes which employ about 1 wt. % PCA to about 10 wt. % PCA based on the weight of the leady oxide in the paste show improved and accelerated formation of 4BS as well as accelerated oxidation of free Pb vs. cure time of the wet paste.

PCA modified pastes may be heated over a wide range of flash dry and curing conditions of temperature and relative humidity to achieve the desired conversion of leady oxide to 4BS and/or 3BS.

Uses of PCA Modified Pastes

PCA modified pastes may be used to produce battery plates, both positive and negative, for a variety of lead-acid battery designs, for various markets such as SLI, traction, stationary, standby, reserve, electric vehicle, uninterruptible power, etc. In any of these designs, the electrolyte may be sulfuric acid liquid (flooded), may be absorbed in bibulous separator material (absorptive glass mat), or may be gelled using various forms of silica or other metal oxides.

In another aspect, the PCA, in both an unoxidized and oxidized state, preferably an oxidized state, may be used as a stabilizer for chlorine containing polymers such as polyvinyl polymers, preferably polyvinyl chloride and polyvinyl dichloride, as well as mixtures of polyvinyl polymers with a wide variety of other polymers. In such mixtures, the polyvinyl polymer may be present in an amount of about 1 wt. % to about 99 wt. % based on the weight of the mixture. The PCA may be present in an amount of about 2 wt. % to about 10 wt. % based on the weight of the polyvinyl polymer. Examples of other polymers which may be employed with the chlorine containing polymers include but are not limited to ethylene containing polymers such as polypropylene and polyethylene, acrylonitrile polymers such as acrylonitrile butadiene styrene, and the like. The PCA employed may vary in color from tan and gray to white, preferably white, or “near-white”. Tan colored PCA may be whitened by treatment with acids such as sulfuric acid. Typically, tan colored PCA is whitened by treatment with 8 M sulfuric acid at about 60° C. to about 100° C. for about 1 min. to about 30 min. Gray colored PCA also may be whitened by treatment with acids such as sulfuric. Typically, gray colored PCA is whitened by treatment with 8 M sulfuric acid at temperatures of about 60° C. to about 100° C. for about 1 min. to about 30 min., or by exposure to temperatures of about 45° C. to about 55° C. at about 45% relative humidity to about 55% relative humidity for about 10 min. to about 24 hr. without acid.

The particle sizes of PCA which may be employed as plastics additives typically are about 1 micron to about 70 microns. The PCA starting material which is employed to produces these particle sizes typically measures about 1 mm diameter to about 6 mm diameter and is oxidized in flowing air. Oxidation of the PCA may be performed in a wide variety of devices such as batch ovens, tunnel dryers, and fluidized beds. Typical air flow rate is about 10 cfm to about 1000 cfm at about 45° C. to about 55° C. at about 45% relative humidity to about 55% relative humidity until the desired color is achieved. The resulting oxidized PCA typically has a moisture content of less than about 0.5%. Then the temperature is raised to about 150° C. and the humidity of the air is decreased to 0% to effect drying. The residue of free Pb in PCA for use as plastics additives may be adjusted from less than about 20% to about 0% to provide lubrication while also providing a desirable color.

The invention is further described below by reference to the following non-limiting examples.

### EXAMPLE 1A

Formation of PCA

Paste that includes 4540 gms leady oxide, 400 ml water and 440 ml of 50 wt. % sulfuric acid is heated to 90° C. for 5 min to produce PCA. The PCA material cured for 96 hrs in a Blue M VP-100 environmental chamber at 91° C. and 95% RH. Analysis of the PCA by XRD before curing shows relatively large amounts of 3BS, relatively small amounts of 4BS, unreacted PbO and residual free Pb. Analysis of the PCA by XRD after curing.

### EXAMPLE 1B

PCA Modified Battery Paste

A mixture that includes 4540 gm leady oxide, 400 ml water and 440 ml of 50 wt. % sulfuric acid is heated to 90° C. for 10 min to produce PCA. 4540 gms of the PCA are mixed with 1000 gms of leady oxide, 100 ml water and 100 ml of 50 wt. % sulphuric acids. The resulting PCA modified paste which has a brownish color is pasted onto grids. The pasted grids are cured in the environmental chamber employed in example 1A at 91° C. at 95% RH for 96 hrs.

Analysis of the cured PCA modified paste by XRD shows that the cured paste has 4BS and residual free Pb. SEM of the cured paste show 4BS crystals which have an average length of 30 microns with crystal twinning and numerous multiaxial crystal groupings. SEM also shows fractal growth of 4BS. XRD analyses, as determined by matrix-flushing, quantitative X-ray diffraction, are summarized in Table 1. Table 1 shows the amounts of free Pb, 4BS and 3BS in the PCA modified battery paste as a function of cure time at 91° C. where all amounts are expressed as weight percents based on the total weight of the cured PCA modified paste.

TABLE 1

| Cure Time, | | | | |
|---|---|---|---|---|
| Hr at 91° C. | Free Pb wt. % | 4BS wt. % | 3BS wt. % | PbO |
| 1 | 9.2 | 39.6 | 32.0 | Remainder |
| 2 | 9.1 | 46.4 | 19.9 | Remainder |
| 4.5 | 10.0 | 53.9 | 17.7 | Remainder |
| 18 | 8.6 | 60.9 | 19.4 | Remainder |
| 26 | 8.2 | not | not | Not |
| | | analyzed | analyzed | analyzed |
| 60 | 7.5 | not | Not | Not |
| | | analyzed | analyzed | analyzed |

### EXAMPLES 2A-2F

These examples show the effect of increasing additions of PCA. The PCA employed is dried and ground to finer than 100 mesh before use.

### EXAMPLE 2A

Paste that includes 4540 gm leady oxide, 400 ml water, 440 ml of 50 wt. % sulfuric acid and 0 wt. % PCA is cured in a Blue M VP-100 environmental chamber is cured according to procedure C2. Procedure C2 entails curing at 85 C. at 95% RH for 48 hr.

### EXAMPLE 2B

The procedure of example 2A is followed except that the paste includes 5 wt. % PCA based on the weight of leady oxide.

### EXAMPLE 2C

The procedure of example 2A is followed except that the paste includes 10 wt. % PCA based on the weight of leady oxide.

### EXAMPLE 2D

Battery paste that includes 4540 gm leady oxide, 400 ml water, and 440 ml of 50 wt. % sulfuric acid and 0 wt. % PCA is cured according to procedure C3. Procedure C3 entails curing at 57 C. at 10% RH for 48 hr.

### EXAMPLE 2E

The procedure of example 2D is followed except that the paste includes 5wt. % PCA based on the weight of leady oxide

### EXAMPLE 2F

The procedure of example 2D is followed except that the paste includes 10 wt. % PCA based on the weight of leady oxide. The results are shown in Table 2.

TABLE 2

| | | | | | | | | Surface |
|---|---|---|---|---|---|---|---|---|
| | Curing | wt. % | wt. % | wt. % | wt. % | | Total pore | area |
| Ex. | method | PCA | Pb¹ | 3BS^{1A} | 4BS^{1A} | % Porosity^{1B} | vol. cc/g^{1C} | m²/gm^{1D} |
| 2A | C2 | 0 | 3.03 | 12 | 7 | 60.10 | 0.1696 | 1.10 |
| 2B | C2 | 5 | 0.42 | 3 | 69 | 57.71 | 0.1558 | 1.57 |
| 2C | C2 | 10 | 0.91 | 4 | 45 | 55.27 | 0.1407 | 0.25 |
| 2D | C3 | 0 | 3.82 | 0 | 32 | 60.99 | 0.1754 | 0.10 |
| 2E | C3 | 5 | 0.5 | 7 | 59 | 58.71 | 0.1621 | 0.37 |
| 2F | C3 | 10 | 0.99 | 4 | 55 | 60.35 | 0.1737 | 0.23 |

¹Determined by wet chemical analysis
^{1A}Determined by X-ray diffraction
^{1B}Determined by mercury intrusion porosimetry
^{1C}Determined by mercury intrusion porosimetry
^{1D}Determined by BET analysis

### EXAMPLES 3A-3C

These examples show that PCA produces more of the desired 4BS than does red lead

### EXAMPLE 3A

A red lead modified battery paste that includes 4540 gm leady oxide, 400 ml water, 440 ml 50 wt. % sulfuric acid and 10 wt. % of pure red lead additive (Pb₃O₄) is cured at 85° C. at 95% RH for 48 hr. The amount of the red lead additive is based on the weight of leady oxide. Visual evaluation showed that the resulting cured paste is very hard and not very porous. XRD shows that the cured paste has 3 wt. % 4BS.

### EXAMPLE 3B

The red lead modified paste of Example 3A is further modified by addition of 5 wt. % PCA based on the weight of the leady oxide. The PCA modified paste is cured at 85° C. at 95% RH for 48 hr. The PCA is prepared as in example 1A but is subsequently dried and ground to finer than 100 mesh. Visual evaluation of the cured PCA modified paste shows that it is soft and porous. XRD shows the presence of 73 wt. % 4BS.

### EXAMPLE 3C

A battery paste that includes 4540 gms leady oxide, 400 ml water, 440 ml 50 wt. % sulfuric acid and 10 wt. % PCA based on weight of leady oxide is prepared by mixing. The PCA employed is made as in example 1A except that red lead is substituted for leady oxide. This PCA, hereinafter “red lead PCA”, is dried at 120° C. and ground to finer than 100 mesh before addition to the battery paste. The red lead PCA modified paste is cured for 48 hr in the environmental chamber employed in example 1A at 85° C. and 95% RH. Visual inspection shows that the cured paste is as hard but is more porous than the product of Example 3A. XRD shows 53 wt. % 4BS.

### EXAMPLES 4A-4G

These examples show that pastes which employ PCA produce better discharge performance than pastes which do not include PCA

Pasted cured plates without and with 2.5% PCA by weight of leady oxide were supplied by East Penn Mfg. Co. The paste includes leady oxide, water and sulfuric acid. These plates are assembled into 3 plate cells which employ one positive plate and two negative plates. The cells are soaked in an aqueous solution of sulfuric acid with a density of 1.24 gms/cc and then formed. The formation method entails applying varying amounts of electric current for successive time periods over 43.75 hrs to a cell that has previously been soaked in 1.24 gms/cc density aqueous sulfuric acid electrolyte. The forming current is applied to a soaked cell according to the following schedule:
1. 0.33 amps for 2.0 hrs
2. 1.41 amps for 10 hrs
3. 1.25 amps for 7.0 hrs
4. 0. amps for 1.0 hrs
5. 1.00 amps for 5.0 hrs
6. 0.80 amps for 5.5 hrs
7. 0.66 amps for 7.5 hrs
8. 0.00 amps for 1.0 hrs
9. 0.60 amps for 2.75 hrs
10. 0.35 amps for 2.0 hrs

After formation, the cells are cycle 3 times by connection to an electronic load bank (for discharge) or to a power supply (for charge). The discharge rate of the cell is at the reserve capacity (“RC”) rate. RC is measured as discharge time in seconds per gram of dried paste for discharge of a cell at 25 amperes discharge current to a 1.75 volt cutoff at 25 C. For all these examples, RC is prorated for a 3 plate cell that includes two anodes and one cathode. The soak time is varied from 15 minutes to 3 hr. On average, the PCA enhanced positive plates gave 9 wt. % more discharge capacity than the control examples which employed plates produced without PCA additive. The results are shown in Table 3.

TABLE 3

| EX. | Soak Time | | RC1^{1,2} | RC2^{1,2} | RC3^{1,2,} | RC1^{2,3} | RC2^{2,3} | RC3^{2,3} |
|---|---|---|---|---|---|---|---|---|
| 4A | 15 | min | 14.16 | 18.44 | 17.68 | 16.5 | 20.36 | 19.37 |
| 4B | 15 | | 15.02 | 19.28 | 19.15 | 17.2 | 21.48 | 21.41 |
| 4C | 15 | | 15.02 | 19.56 | 19.56 | 16.5 | 20.11 | 20.08 |
| 4D | 15 | | 15.77 | 17.81 | 18.12 | 17.73 | 19.66 | 19.97 |
| 4E | 60 | | 15.02 | 17.41 | 17.37 | 18.25 | 19.73 | 20.08 |
| 4F | 90 | | 19.55 | 20.20 | 20.14 | 18.08 | 22.46 | 22.18 |
| 4G | 180 | | 14.81 | 18.60 | 18.80 | 15.44 | 19.13 | 19.73 |

¹Control-no PCA employed
²The number following RC is the discharge number, i.e. RC1 is the first test discharge, RC2 is the subsequent test discharge after an intermediate recharge, and RC3 is the final test discharge after an intermediate recharge.
³2.5% PCA employed

### EXAMPLES 5A-5E

These examples show that pastes which employ PCA have improved cycle life performance.

### EXAMPLE 5A

Control

An industrial battery flat positive plate is pasted with a mixture of leady oxide, water and sulfuric acid and that includes 5% red lead based on weight of leady oxide. The plate is cured at 80° C. at 98% RH for 48 hours in a commercial plate curing humidity chamber. In curing, the plates are racked, i.e. hung vertically from frames or racks, with spaces between adjacent plates.

### EXAMPLE 5B

The process of example 5A is performed except that the plate is pasted with a mixture of leady oxide, water and sulfuric acid and 5 wt. % PCA based on weight of leady oxide. For curing, plates are racked.

### EXAMPLE 5C

The process of example 5B is performed except that curing is performed by 150° F. flash drying. For curing, plates are racked.

### EXAMPLE 5D

The process of example 5B is performed except that curing is performed by 400° F. flash drying. For curing, plates are racked with 2 mm spacing between adjacent plates.

### EXAMPLE 5E

The process of example 5D is performed except that the racked pasted plates are cured in a tightly packed condition where the spacing between adjacent plates is 0.1 mm.

As shown in Table 4, PCA reduces curing time by 8 hrs. Table 4 also shows that, in most batches, PCA grows 4BS. In contrast, red lead may or may not produce 4BS and also may produce the less-desired 3BS.

TABLE 4A
% Free Pb In Cured Paste

| | Cure Time | Cure Time | Cure Time | Cure Time | Cure Time |
|---|---|---|---|---|---|
| Example | 0 hr | 10 hr | 18 hr | 26 hr | 32 hr |
| 5A | — | 19 | 2.1 | 1.2 | 1.4 |
| 5B | 18.1 | 15 | 1.8 | 1.3 | 1.4 |
| 5C | 18.1 | 12.4 | 1.6 | 1.4 | 1.4 |
| 5D | 18.1 | 7.2 | 2.2 | 1.3 | 1.6 |
| 5E | 18.1 | 13.5 | 2.1 | 0.87 | 1 |

TABLE 4B
% 3BS in Cured Paste

| | Cure Time | Cure Time | Cure Time | Cure Time | Cure Time |
|---|---|---|---|---|---|
| Example | 0 hr | 10 hr | 18 hr | 26 hr | 32 hr |
| 5A | — | 8 | 8 | 26 | 37 |
| 5B | 82 | 0 | 0 | 0 | 0 |
| 5C | 82 | 5 | 5 | 6 | 10 |
| 5D | 82 | 16 | 10 | 7 | 10 |
| 5E | 82 | 3 | 3 | 4 | 10 |

TABLE 4C
% 4BS in Cured Paste

| | Cure Time | Cure Time | Cure Time | Cure Time | Cure Time |
|---|---|---|---|---|---|
| Example | 0 hr | 10 hr | 18 hr18 hr | 26 hr | 32 hr32 hr |
| 5A | — | 51 | 55 | 26 | 15 |
| 5B | 5 | 5 | 5 | 7 | 10 |
| 5C | 5 | 58 | 63 | 63 | 48 |
| 5D | 5 | 28 | 38 | 43 | 33 |
| 5E | 5 | 61 | 58 | 54 | 46 |

The pasted plates in Examples 5A-5E are assembled into cells, formed, and cycle tested at 100% depth-of-discharge according to Fed. Spec. W-B-133B. With PCA, the initial capacity was acceptable. The control cells had higher initial capacities since they had not been equalized in electrolyte concentration until after the 3^{rd} cycle. PCA provides longer cycle life, as seen at high cycle numbers of more than 1000. The average capacity with PCA also is higher and more consistent between duplicate strings of cells on test. The results are shown in Table 6.

TABLE 6
Capacities

| | Capacity | Capacity | Capacity | Capacity % | Capacity % |
|---|---|---|---|---|---|
| Ex- | % | % | % | Cycle | Cycle |
| ample | cycle 1 | Cycle 3 | Cycle 10 | 1000 | 1600 |
| 5A | 116.9 | 125.10 | 102.40 | 82.5 | 78 |
| 5B | 97.2 | 103.0 | 101.5 | 84.5 | 83 |
| 5C dry | 91.5 | 95.6 | 95.3 | 86 | 84 |

### EXAMPLE 6

Use of PCA in PVC Plastic for Cable Insulation

5 gms. PCA produced in accordance with example 1A is oxidized by exposure to a temperature of 45 C. and a relative humidity of 45% in a mechanical-convection type environmental chamber for 24 hrs. 5 gms. of the resulting PCA is mixed with 100 grams of polyvinyl chloride (PVC), 36 grams of dioctyl phthalate(DOP), 18 grams chlorinated paraffin, 1 gram calcium stearate, 20 grams of calcium carbonate mineral and 10 grams of clay mineral.

### EXAMPLE 7

Use of PCA in PVC Plastic for Cable Sheathing

5 gms. PCA produced in accordance with example 1A is oxidized by the conditions listed in Example 6. The resulting PCA is mixed with 100 grams of polyvinyl chloride (PVC) resin, 36 grams of DOP, 18 grams chlorinated paraffin, 1 gram calcium stearate, 40 grams of calcium carbonate mineral, and 10 grams of clay mineral.

1. The reaction product formed heating a battery paste to a temperature of about 80° C. to about 90° C. for about 5 min. to about 10 min., wherein the battery paste includes sulfuric acid in an amount of about 5 wt. % to about 6 wt. %, water in an amount of about 12 wt. % to about 16 wt. %, and balance leady oxide, all amounts based on total weight of sulphuric acid, water and leady oxide.

2. The reaction product formed heating a battery paste to a temperature of about 70° C. to about 90° C. for about 10 min. to about 90 min., wherein the battery paste includes sulfuric acid in an amount of about 3 wt. % to about 10 wt. %, water in an amount of about 10 wt. % to about 20 wt. %, and balance leady oxide, all amounts based on total weight of sulphuric acid, water and leady oxide.

3. A method of manufacture of a stablizing additive comprising forming a mixture of sulfuric acid in an amount of about 5 wt. % to about 6 wt. %, water in an amount of about 12 wt. % to about 16 wt. %, and balance leady oxide, all amounts based on total weight of sulphuric acid, water and leady oxide, and heating the mixture to a temperature of about 80° C. to about 90° C. for about 5 min. to about 10 min.

4. A method of manufacture of a stabilizing additive comprising forming a mixture of sulfuric acid in an amount of about 3 wt. % to about 10 wt. %, water in an amount of about 10 wt. % to about 20 wt. %, and balance leady oxide, all amounts based on total weight of sulphuric acid, water and leady oxide, and heating the mixture to a temperature of about 70° C. to about 90° C. for about 10 min. to about 90 min.

5. A battery paste comprising a paste curing additive in admixture with a composition comprising sulphuric acid, water and leady oxide,
wherein the additive is the undried reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide, and
wherein the additive is present in the compositon in an amount of about 50 wt. % to about 60 wt. % based on the weight of leady oxide.

6. A battery paste comprising a paste curing additive in admixture with a composition comprising sulphuric acid, water and leady oxide,
wherein the additive is the undried reaction product formed by heating a mixture of sulfuric acid, water and leady oxide wherein the sulphuric acid is present in the mixture in an amount of about 3 wt. % to about 10 wt. %, the water is present in the mixture in an amount of about 10 wt. % to about 20 wt. %, and leady oxide is present in the mixture in an amount that is the balance of the mixture, all amounts based on total weight of the mixture of sulphuric acid, water and leady oxide, and
wherein the additive is present in the compositon in an amount of about 5 wt. % to about 95 wt. % based on the weight of leady oxide.

7. A battery paste comprising a paste curing additive in admixture with a composition comprising sulphuric acid, water and leady oxide,
wherein the additive is the dried reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide, and
wherein the additive is present in the composition in an amount of about 1 wt. % to about 10 wt. % based on the weight of leady oxide.

8. A battery paste comprising a paste curing additive in admixture with a composition comprising sulphuric acid, water and leady oxide,
wherein the additive is the undried reaction product formed by heating a mixture of sulfuric acid, water and leady oxide wherein the sulphuric acid is present in the mixture in an amount of about 3 wt. % to about 10 wt. %, the water is present in the mixture in an amount of about 10 wt. % to about 20 wt. %, and leady oxide is present in the mixture in an amount that is the balance of the mixture, all amounts based on total weight of the mixture of sulphuric acid, water and leady oxide, and
wherein the additive is present in the composition in an amount of about 1 wt. % to about 95 wt. % based on the weight of leady oxide.

9. A polymeric composition comprising a paste curing additive in admixture with a chlorine containing polymer comprising,
a chlorine containing polymer and a paste curing additive present in an amount of about 2 wt. % to about 10 wt. % based on the weight of the chlorine containing polymer,
wherein the additive is the oxidized reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide, and
wherein the additive has a particle size of about 1 micron to about 70 microns.

10. A polymeric composition comprising a paste curing additive in admixture with a chlorine containing polymer comprising,
a chlorine containing polymer and a paste curing additive present in an amount of about 2 wt. % to about 10 wt. % based on the weight of the chlorine containing polymer,
wherein the additive is the unoxidized reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide,
wherein the additive has a particle size of about 1 micron to about 70 microns.

11. A battery plate pasted with a battery paste comprising a paste curing additive in admixture with a composition comprising sulphuric acid, water and leady oxide,
wherein the additive is the undried reaction product formed by heating a mixture of sulfuric acid, water and leady oxide wherein the sulphuric acid is present in the mixture in an amount of about 3 wt. % to about 10 wt. %, the water is present in the mixture in an amount of about 10 wt. % to about 20 wt. %, and leady oxide is present in the mixture in an amount that is the balance of the mixture, all amounts based on total weight of the mixture of sulphuric acid, water and leady oxide, and
wherein the additive is present in the composition in an amount of about 5 wt. % to about 95 wt. % based on the weight of leady oxide.

12. A battery plate pasted with a battery paste comprising a paste curing additive in admixture with a composition comprising sulphuric acid, water and leady oxide,
wherein the additive is the dried reaction product formed by heating a mixture of sulfuric acid, water and leady oxide wherein the sulphuric acid is present in the mixture in an amount of about 5 wt. % to about 6 wt. %, the water is present in the mixture in an amount of about 12 wt. % to about 16 wt. %, and leady oxide is present in the mixture in an amount that is the balance of the mixture, all amounts based on total weight of the mixture of sulphuric acid, water and leady oxide, and
wherein the additive is present in the composition in an amount of about 1 wt. % to about 10 wt. % based on the weight of leady oxide.

13. A battery plate pasted with a battery paste comprising a paste curing additive in admixture with a composition comprising sulphuric acid, water and leady oxide,
wherein the additive is the undried reaction product formed by heating a mixture of sulfuric acid, water and leady oxide wherein the sulphuric acid is present in the mixture in an amount of about 3 wt. % to about 10 wt. %, the water is present in the mixture in an amount of about 10 wt. % to about 20 wt. %, and leady oxide is present in the mixture in an amount that is the balance of the mixture, all amounts based on total weight of the mixture of sulphuric acid, water and leady oxide, and wherein the additive is present in the composition in an amount of about 1 wt. % to about 95 wt. % based on the weight of leady oxide.
